(19) United States
(12) Patent Application Publication
(10) Pub. No.: US 2015/0240939 A1
(43) Pub. Date: Aug. 27, 2015

(54) System And Method For Controlling Transmission Of A Machine

(71) Applicant: Caterpillar Inc., Peoria, IL (US)

(72) Inventor: Xinyu Ge, Peoria, IL (US)

(73) Assignee: Caterpillar Inc., Peoria, IL (US)

(21) Appl. No.: 14/709,481

(22) Filed: May 12, 2015

(51) Int. Cl. F16H 61/02; F16H 59/74; F16H 59/50

(52) U.S. Cl. CPC F16H 61/0213; F16H 59/50; F16H 59/74; F16H 2061/0216; F16H 2061/022; F16H 2061/0232; F16H 2061/0234; F16H 2059/743

(57) ABSTRACT

A method of operating a machine having an engine and a transmission drivably coupled to the engine is provided. The method includes determining a power usage value of a work cycle of the machine based at least on a plurality of machine parameters and determining an operating cost map based at least on a fuel price and a Diesel Exhaust Fluid (DEF) price. The method includes determining a current operating cost based on the operating cost map and a current operating condition that is based on at least one of the machine parameters. The method includes determining a low cost operating condition corresponding to an operating cost less than the current operating cost. The low cost operating condition corresponds to a power of the machine that is greater than or equal to the power usage value. The method includes regulating the transmission to obtain the low cost operating condition.

### TECHNICAL FIELD

The current disclosure relates to a transmission of a machine, and more particularly to a system and a method for controlling the transmission for minimizing overall fluid consumption of the machine.

### BACKGROUND

Machines, such as a wheel loader, a dozer, and the like, are typically designed to perform a variety of different operations. Generally, such operations include various work cycles that may be performed repetitively. The work cycles may include operations, such as a dig segment, a lift segment, a dump segment and the like. Moreover, different amounts of power may be required to perform one or more of these operations. Many methods have been implemented in the past to improve an efficiency of the machine while performing these operations. In one example, an engine speed may be reduced based on power usage of the machine for these work cycles.

For reference, U.S. Pat. No. 8,095,280 relates to a method for controlling an engine of a machine includes a step of setting an initial engine speed of the engine based on a position of an operator engine speed selection device. The machine is operated for a period of time at the initial engine speed, and a power usage value for the machine during that period of time is identified. The initial engine speed of the engine is then lowered to a reduced engine speed corresponding to the power usage value.

However, the machines may also include aftertreatment systems, for example, a Diesel Emission Fluid (DEF) system employed to reduce emissions in an exhaust from the engine. Decreasing an engine speed based on the power usage may decrease a fuel consumption in some cases. However, reduction in the fuel consumption may increase an amount of NOx in the exhaust. As such, an increased amount of DEF may be required to reduce the amount of NOx in the exhaust. With such an implementation, an operation cost that includes the price of DEF may also be increased.

### SUMMARY OF THE DISCLOSURE

In one aspect of the current disclosure, a method of operating a machine is provided. The machine includes an engine and a transmission drivably coupled to the engine. The method includes determining a plurality of machine parameters, and determining a power usage value of a work cycle of the machine based at least on the machine parameters. The method also includes receiving a fuel price and a Diesel Exhaust Fluid (DEF) price, and determining an operating cost map based at least on the fuel price and the DEF price. The operating cost map includes a relationship between an operating condition of the machine and a corresponding operating cost. The operating condition is based on at least one of the machine parameters. The method further includes determining a current operating cost based on the operating cost map and a current operating condition of the machine, and determining a low cost operating condition corresponding to an operating cost less than the current operating cost. The low cost operating condition corresponds to a power of the machine that is greater than or equal to the power usage value. The method further includes regulating the transmission to obtain the low cost operating condition.

Other features and aspects of this disclosure will be apparent from the following description and the accompanying drawings.

### BRIEF DESCRIPTION OF THE DRAWINGS

FIG. 1 is a side view of a machine having a work implement, according to an exemplary embodiment of the present disclosure;

FIG. 2 is a block diagram of a control system of the machine, according to an embodiment of the present disclosure;

FIG. 3 is a flowchart for an adjustment strategy implemented by the control system, according to an embodiment of the present disclosure;

FIG. 4 is an exemplary graph illustrating power usage values for a work cycle of the machine;

FIG. 5 is an exemplary operating cost map; and

FIG. 6 is a flowchart for a method of operating the machine, according to an embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

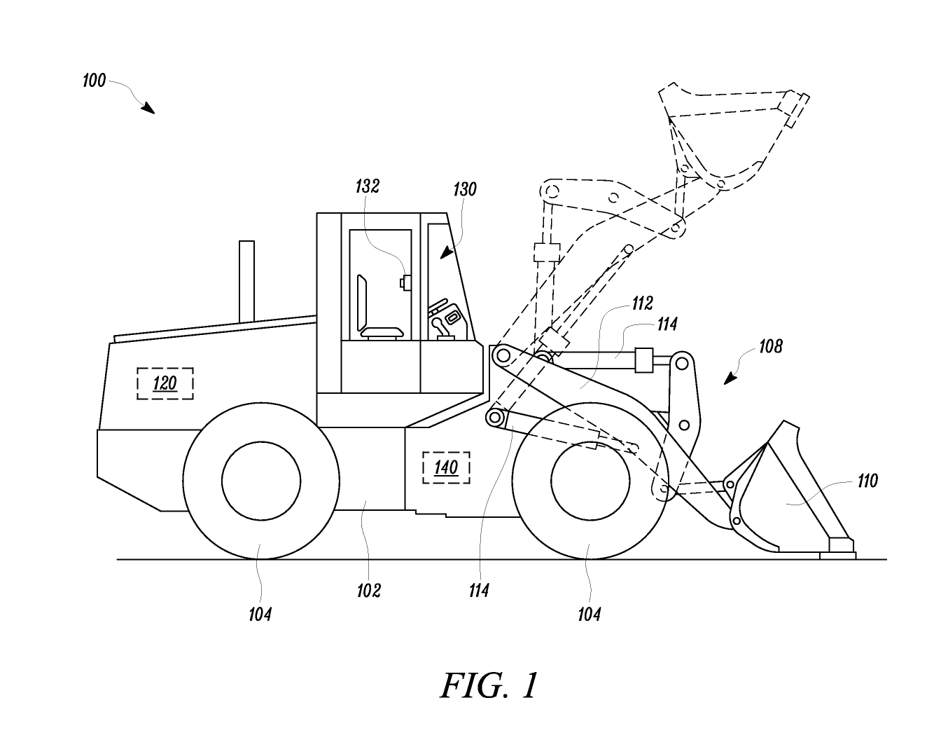

FIG. 1 illustrates a side view of a machine 100, according to an exemplary embodiment of the current disclosure. In the illustrated embodiment, the machine 100 is a wheel loader. The wheel loader may perform various earth moving operations based on a repetitive work cycle that will be described in detail below. However, the machine 100 may embody any machines, such as an excavator, a dozer, or any other on-highway or off-highway vehicle used to perform work operations based on a repetitive work cycle for the purpose of construction, mining, quarrying, and the like.

The machine 100 includes a frame 102 configured to support a set of ground engaging members 104. In the illustrated embodiment, the set of ground engaging members 104 are wheels configured to propel the machine 100. Alternatively, the set of ground engaging members 104 may be track assemblies.

The machine 100 also includes an implement system 108 for performing various tasks, such as digging, levelling, dumping and the like. The implement system 108 may include an implement 110, such as a bucket, attached to a front end of the machine 100. In the illustrated embodiment, the implement system 108 includes a pair of arms 112 (one of the arms 112 shown in FIG. 1) movably coupled to the frame 102 at the front end of the machine 100. Further, the implement 110 may be movably attached to the pair of arms 112. The pair of arms 112 may be moved upward and downward in order to lift and lower the implement 110. Moreover, the pair of arms 112 may also be configured to provide a tilting movement to the implement 110.

Further, the implement system 108 includes one or more hydraulic cylinders 114 configured to control a lifting and/or tilting movement of the implement 110. The hydraulic cylinders 114 may be in communication with a fluid source, such as a hydraulic pump and a fluid tank, via a valve assembly. The valve assembly may be configured to control a flow of the hydraulic fluid to and from the hydraulic cylinders 114, thereby controlling a movement of the implement 110.

In various other examples, the implement may be coupled to the machine using other types of linkage systems and/or assemblies so as to perform the operations. Further, the implement 110 may be configured to pivot, rotate, slide, swing, and/or move relative to the frame 102 of the machine 100 in any other manner known in the art. In various other embodiments, the implement 110 may include any device used in the performance of a task. For example, the implement 110 may include a blade, a shovel, a hammer, an auger, a ripper, or any other task-performing device.

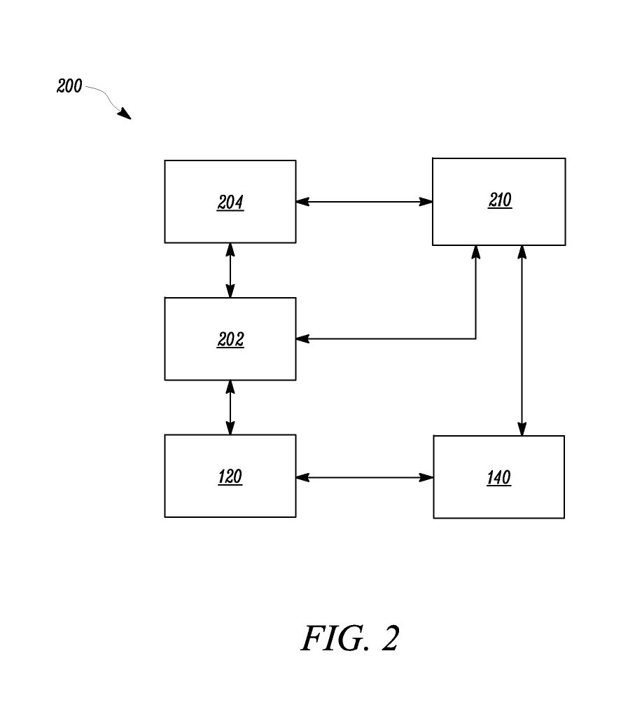

Referring to FIGS. 1 and 2, the machine 100 further includes an operator station or cab 130 containing controls or input devices for operating the machine 100. The cab 130 may also include one or more input devices (not shown) for propelling the machine 100, controlling the implement 110 and/or other machine components. In an example, the cab may include input devices, such as one or more joysticks, levers, switches and pedals disposed within the cab 130 and may be adapted to receive input from an operator indicative of a desired movement of the implement 110 and the set of ground engaging members 104.

Further, the machine 100 also includes a machine controller 204 for controlling a movement of the implement 110. Additionally, the machine controller 204 may be configured to control a direction of movement of the machine 100, such as a forward or reverse direction.

The machine 100 further includes an engine 120 to supply power to various components including, but not limited to, the set of ground engaging members 104, and the implement 110. For example, the engine 120 may drive the hydraulic pump (not shown) associated with the implement system 108. The engine 120 may embody, for example, a diesel engine, a gasoline engine, a gaseous fuel-powered engine, or any other type of combustion engine. It is contemplated that the machine 100 may include additional power sources, such as, for example, a fuel cell, a power storage device, or another suitable source of power.

The engine 120 may be associated with an Electronic Control Module (ECM) 202 configured to control one or more parameters of the engine 120. Moreover, the ECM 202 may be in communication with the machine controller 204. Further, the ECM 202 may also include various maps, look-up tables etc. for relationships between various parameters of the engine 120 or relationships between the parameters of the engine 120 and the parameters of the machine 100. The ECM 202 may be configured to determine a fuel rate of a fuel injected into cylinders of the engine 120 for a particular operating condition of the engine 100, for example, a specific combination of the engine speed, and the torque. Accordingly, a brake specific fuel consumption (BSFC) that is indicative of the fuel rate may be predetermined and stored in the ECM 202 as maps or look-up tables. It should be noted that, the position of the engine 120 as illustrated in FIG. 1, is exemplary and may vary depending on a type of the machine 100 and other parameters.

The engine 120 may generate exhaust gas as a byproduct of combustion. The exhaust gas includes nitrogen oxides (NOx) among other components. The machine 100 may include an aftertreatment system (not shown) that is used to treat an exhaust gas flow. For example, the aftertreatment systems may include a Selective Catalytic Reduction (SCR) catalyst. In such systems, a reductant, such as a Diesel Emission Fluid (DEF) is injected into the exhaust gas flow upstream of the SCR catalyst. Thereafter, the NOx may be reduced to diatomic nitrogen (N2) and water with the help of the SCR catalyst. Moreover, the machine controller 204 or the ECM 202 may be configured to regulate an amount of the DEF i.e., a DEF rate that is being injected into the exhaust gas flow based on an amount of NOx in the exhaust. Moreover, the DEF rates may be predetermined for a specific requirement of the engine speed, the torque or other relevant parameters and stored as maps or look-up tables.

The engine 120 may also include various other sensing devices, such as an engine speed sensor (not shown) for determining a speed of the engine 120. The engine speed sensor may be associated with a camshaft (not shown) or other component of the engine 120 from which the speed of the engine 120 may be determined. Further, a sensor (not shown) may also be operatively coupled to suitable components of the engine 120, such as but not limited to, a cam shaft, an output shaft or other appropriate component to sense an engine torque. Alternatively, the ECM 202 or the machine controller 204 may be configured to determine at least one of the speed and the torque of the engine 120 based on other parameters by referring to look-up tables, reference maps, mathematical relations and the like stored in a memory associated with the machine controller 204. In an example, the torque of the engine 120 may be determined based on the speed of the engine 120 and a fuel quantity injected into cylinders of the engine 120. In the illustrated embodiment, the cab 130 includes a speed selection device 132, such as, for example, a throttle, for enabling an operator to select a desired engine speed.

The machine 100 further includes a transmission 140 drivably coupled to the engine 120 for receiving power therefrom. The transmission 140 may be configured to drive the set of ground engaging members 104 of the machine 100. In an embodiment, the transmission 140 may be a hydrostatic Continuously Variable Transmission (CVT) including a variator (not shown) configured to adjust a transmission ratio between the engine 120 and the ground engaging members 104 of the machine 100.

The variator may include a hydraulic motor and a variator hydraulic pump, such as a variable displacement pump, connected to a hydraulic fluid source. In an example, the variator hydraulic pump may include a swash-plate for varying a displacement thereof. The hydraulic motor may be driven by pressurized fluid from the variator hydraulic pump. An output pressure of the hydraulic pump may be controlled by varying an angle of the swash plate. In an example, a setting for the engine speed may be changed by varying a displacement of the variator hydraulic pump. In an embodiment, the transmission 140 may also include pressure sensors configured to determine pressures of the variator hydraulic pump and the hydraulic motor.

Accordingly, the ECM 202 may control a supply of the fuel in one or more cylinders of the engine 120 to control the engine speed based on the setting for the engine speed received from the transmission 140. In another example, a power of the engine 120 or a torque of the engine 120 may be adjusted by varying the displacement of the variator hydraulic pump.

Though the transmission 140 is described as a hydrostatic CVT above, in various other embodiments, the transmission 140 may be an Infinite Variable Transmission (IVT) or other types of automatic transmission systems. Alternatively, the transmission 140 may be a manually controlled transmission. In an embodiment, the machine 100 may also include other components, such as a torque convertor configured to provide variable output speeds and torques to the transmission 140, which in turn may drive the set of ground engaging members 104.

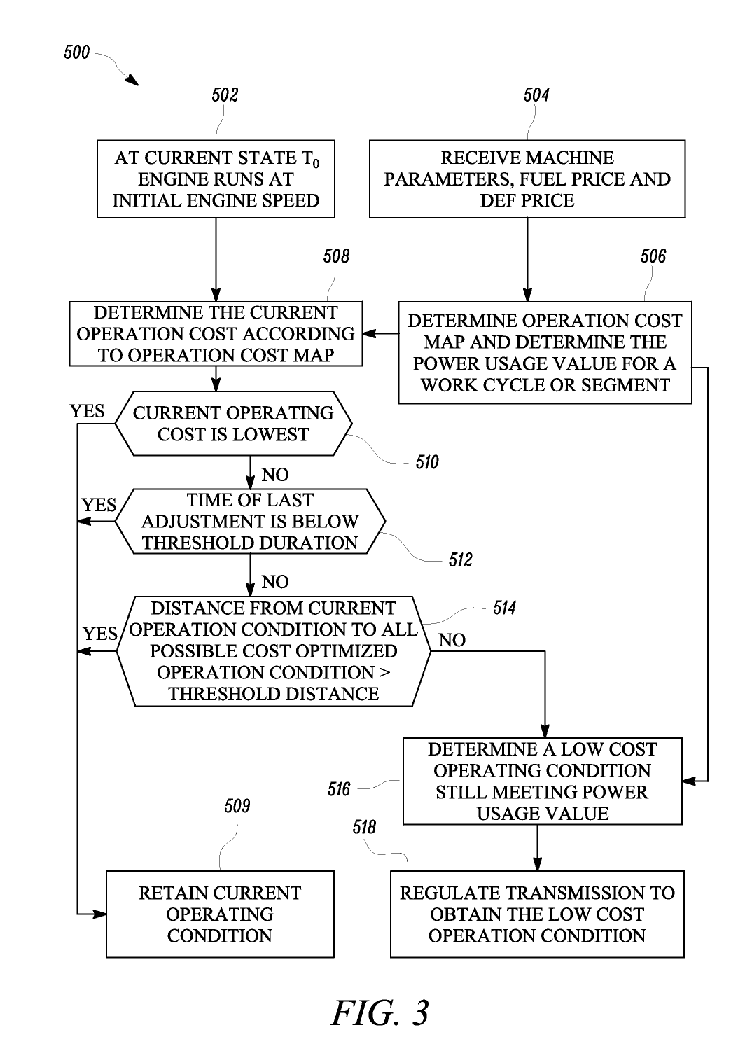

Referring to FIG. 2, a block diagram of a control system 200 for operating the machine 100 is illustrated. The control system 200 may include a controller 210 configured to operate the machine 100 based on an adjustment strategy 500 that will be described in detail later with reference to FIG. 3. The controller 210 may be in communication with the ECM 202 of the engine 120 and the machine controller 204 to receive one or more of the machine parameters.

The controller 210 may be an electronic controller that performs various operations, such as execution of control algorithms, storage and retrieval of data, and other desired operations. The controller 210 may include or access memory, secondary storage devices, processors, and any other components for running an application. The memory and secondary storage devices may be in the form of read-only memory (ROM) or random access memory (RAM) or integrated circuitry that is accessible by the controller 210. Various other circuits may be associated with the controller 210, such as power supply circuitry, signal conditioning circuitry, driver circuitry, and other types of circuitry.

The controller 210 may be a single controller or may include more than one controller disposed to control various functions and/or features of the machine 100. The term “controller 210” is meant to be used in its broadest sense to include one or more controllers and/or microprocessors that may be associated with the machine 100 and that may cooperate in controlling various functions and operations of the machine 100. The functionality of the controller 210 may be implemented in hardware and/or software without regard to the functionality employed. The controller 210 may also use one or more data maps relating to the operating conditions of the machine 100 that may be stored in the memory of the controller 210.

Referring to FIG. 3, an adjustment strategy 500, for implementation by the controller 210, is illustrated, according to an embodiment of the present disclosure. At step 502, the controller 210 may determine a desired engine speed at a current state. In an embodiment, the controller 210 may determine the desired engine speed based on a position of the speed selection device 132 at the current state, for example, time T0. Further, the controller 210 may set an initial engine speed to correspond to the desired engine speed.

At step 504, the controller 210 may determine multiple machine parameters. The machine parameters may include the engine speed, the torque, a payload value, a grade, a travel direction, transmission information of the machine 100, and the like. In an embodiment, the controller 210 may be in communication with one or more sensors disposed in the machine 100 to receive signals indicative of the one or more machine parameters. For example, the controller 210 may be in communication with various pressure sensors associated with the transmission 140 to receive the information related to the transmission 140.

The controller 210 may also be configured to receive information related to the fuel rate and the DEF rate from the ECM 202. The controller 210 may determine the fuel rate and the DEF rate based on maps or look-up tables that includes the fuel rate and the DEF rates for different values of the torque and the engine speed. In an example, the fuel rate may be determined based on a contour map of the BSFC for various torque and engine speeds.

The controller 210 may also be configured to receive a fuel price and a DEF price. In an embodiment, the fuel price and the DEF price for different locations may be stored in the memory and may also be updated from time to time. The locations may include different geographic locations, such as countries, states, and the like. Accordingly, the controller 210 may refer to the memory to determine the fuel price and the DEF price for the current location. In another embodiment, the fuel price and the DEF price may be input manually. In yet another embodiment, the controller 210 may receive the fuel price and the DEF price from an external database over a wireless communication network.

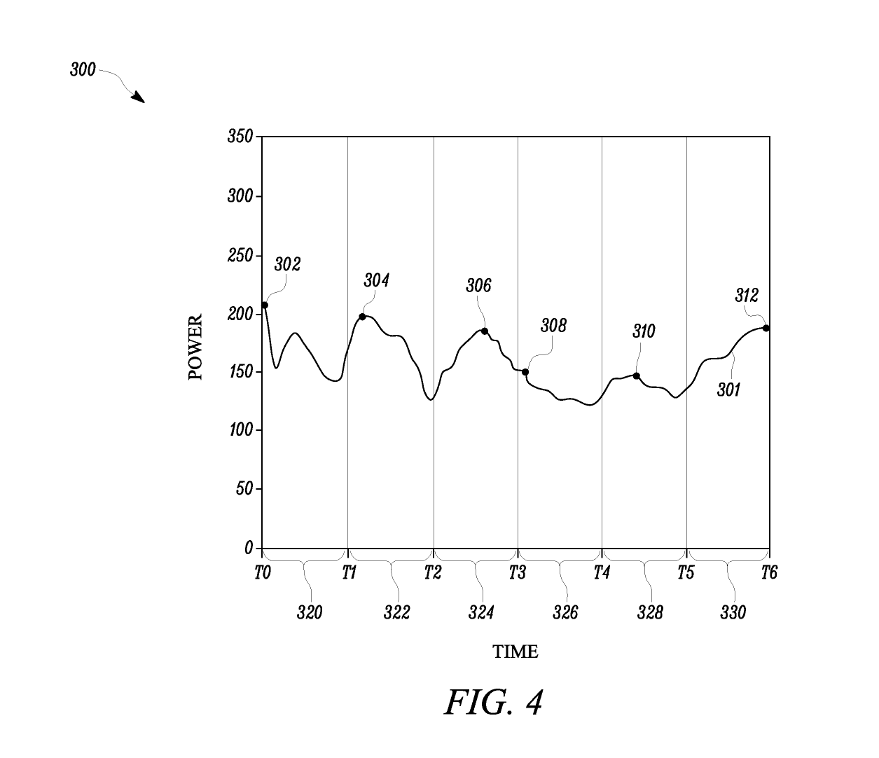

At step 506, the controller 210 may be configured to determine a work cycle for the machine 100 based at least on the machine parameters. Referring to FIG. 4, an exemplary graph 300 of power, shown on the vertical axis, versus time, shown on the horizontal axis, for an operation period of the machine 100 is illustrated. The work cycle of the machine 100 may be divided into a dig segment 320, a reverse lift segment 322, a forward lift segment 324, a dump segment 326, a reverse lower segment 328, and a forward lower segment 330. However, in another embodiment, the work cycle of the machine 100 may be divided into more than or less than the indicated segments based on an application of the machine 100. The work cycle of the machine 100 may be repeated to perform various works, such as earth moving operation. It should be noted that the above segments are provided merely as examples for the purpose of the present disclosure.

The controller 210 may be configured to detect which of the work cycle segments 320-330 is being performed. According to one embodiment, the controller 210 may be configured to detect a transition to each of the work cycle segments 320-330, by monitoring various parameters of the machine 100, such as, a fluid pressure of the hydraulic pump associated with the implement system 108, an output speed of the hydraulic motor and an output pressure of the variator hydraulic pump associated with the transmission 140. In an example, the controller 210 may detect a transition from the dig segment 320 to the reverse lift segment 322 by determining that the implement 110 has engaged a pile of material and/or by determining that the implement 110 is being tilted.

The controller 210 is also configured to determine a power usage value for the work cycle of the machine 100. A power usage line 301, shown on graph 300, may represent power utilized by the machine 100 during a time period between T0 and T6, as determined by the controller 210. Specifically, the power usage line 301 may be representative of the combined power used by all of the power utilizing components of the machine 100, such as, for example, the variator hydraulic pump associated with the transmission 140 and the like. It should be appreciated that the operation period, such as the time period between T0 and T6 depicted on the graph 300, may represent any predetermined amount of time during which the machine 100 is operated.

In an embodiment, the controller 210 may determine the power usage values, shown at points 302, 304, 306, 308, 310, 312, for each of the work cycle segments, 320-330. It should be appreciated that performance of each work cycle segment 320-330 may require a different, but relatively consistent, amount of power from the engine 120.

In one embodiment, the power usage values 302-312 may represent the maximum amount of power demanded from the engine 120 by all of the power utilizing components of the machine 100 during the corresponding work cycle segment. In another embodiment, the power usage values 302-312 may be indicative of the power demand required to operate the machine 100 at a desired productivity level, such as determined by an operator of the machine 100. Alternatively, the power usage values 302-312 may represent any other desired measurement or calculation of power usage.

One skilled in the art should appreciate that the power usage values 302-312 of FIG. 4 may be determined in any of a number of ways. In an embodiment, as referenced above, the controller 210 may be configured to monitor machine parameters, such as various parameters of the transmission 140, to determine, or measure, the amount of power used during the work cycle. The controller 210 may use the machine parameters along with various reference maps, formulas, and/or algorithms stored in memory, to determine power usage values 302-312 for each power utilizing component that is monitored.

In another embodiment, the power usage values 302-312, may be determined based on a payload value for the machine 100. Specifically, the power usage values 302-312, may be correlated to a percent payload in order to determine an estimated power demand based on the measured payload.

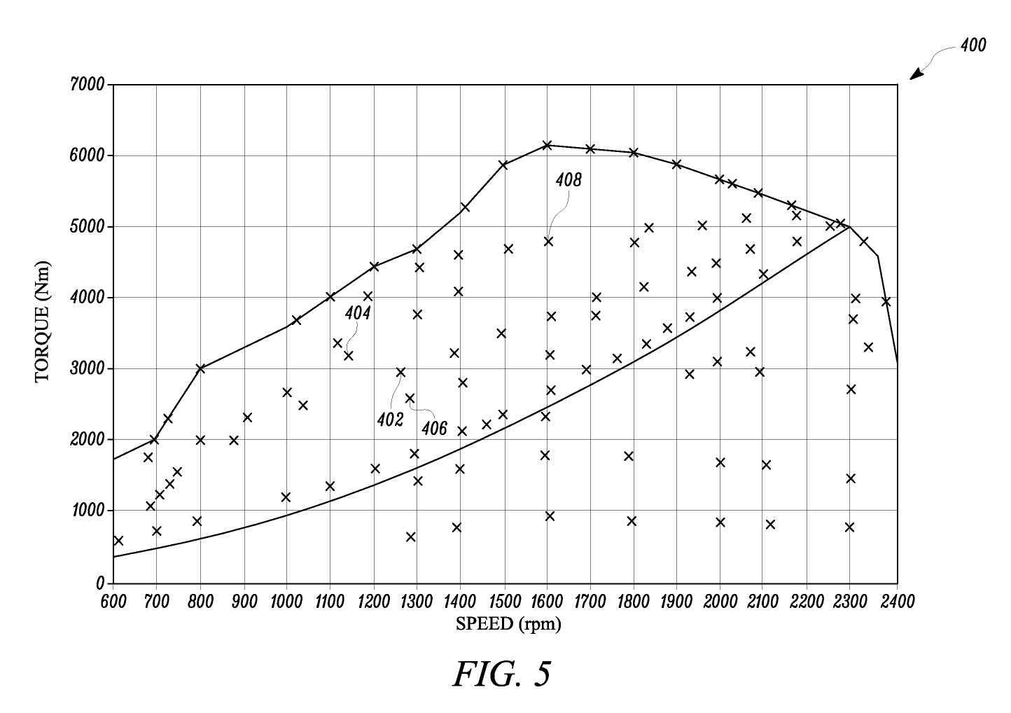

At step 506, the controller 210 may also be configured to determine an operating cost map 400 (shown in FIG. 5) based at least on the fuel price and the DEF price. Moreover, the controller 210 may receive the fuel price and the DEF price corresponding to the current location, time and the like. Referring to FIG. 5, the operation cost map includes a relationship between an operation condition of the machine 100 and a corresponding operating cost. The operating condition may depend on the machine parameters. In an example, the operating condition may depend on the engine speed and the torque. In the illustrated embodiment of FIG. 4, the operating cost map 400 includes a relationship between the torque, the engine speed and a corresponding operating cost.

Although, the operating cost map 400 is shown as a two dimensional plot, it may be recognized that the operating cost may be represented in any number of dimensions or formats that includes a relationship between the operating condition and the corresponding operating cost. In an embodiment, the operating costs in the operating cost map 400 may be determined based on the following equation (1):

Operating Cost=(Fuel rate*Fuel price)+(DEF rate*DEF price) (1)

Further, as described above, the fuel rate and the DEF rate may be determined as a function of the torque and the engine speed. Accordingly, at each of the combinations of the engine speed and the torques, the operating costs may be determined and represented in the operating cost map 400. In other embodiments, various types of equations may be used to determine the operating cost as a function of the fuel rate, the fuel price, the DEF rate, the DEF price and the like.

Further, the operating cost map 400 also includes multiple optimized operating conditions for the machine 100. The controller 210 may be configured to determine multiple discrete cost optimized operating conditions for the work cycle segments 320-330 based on the machine parameters and the corresponding operating cost. In an example, the operating cost in equation (1) may be optimized with respect to the engine speed and the torque on which the fuel rate and the DEF rate are dependent so as to determine the optimized operating conditions. Referring to FIG. 4, exemplary points indicative of cost optimized operating conditions, such as a first cost optimized operating condition 404, a second cost optimized operating condition 406 and a third cost optimized operating condition 408 are illustrated.

At step 508, the controller 210 may determine a current operating cost based on the operating cost map 400 and a current operating condition. In an embodiment, the controller 210 may determine the current operating cost corresponding to the initial engine speed and the torque of the engine 120 using the operating cost map 400. In FIG. 5, an exemplary point indicative of the current operating condition 402 and the corresponding operating cost is shown.

At step 510, the controller 210 may determine if the current operating cost corresponds to a lowest cost for the current operating condition. In an embodiment, the operating cost map 400 may include discrete optimized operating cost lines (not shown). Each of the optimized operating costs lines indicate a constant power and are formed as a locus of the lowest cost points for different operating conditions of the machine 100. The controller 210 may determine the current operating cost as the lowest cost if the current operating cost falls on any of the optimized operating cost lines. In another embodiment, the lowest cost for different segments of the work cycle may be determined and stored in the memory.

The controller 210 may pass the control to step 509 from step 510, if it is determined that the current operating cost is lowest. At step 509, the controller 210 may retain the current operating condition. However, if at step 510, it is determined that the current operating cost is not the lowest, the controller 210 may pass the control to step 512. At step 512, the controller 210 may determine if a time period since the last implementation of the adjustment strategy 500 occurred is greater than a threshold duration. In an example, the threshold duration may be set by an operator. In another example, the threshold duration may be determined based on a type of the machine 100, the engine 120 and the transmission 140, a work cycle and other parameters. For example, the threshold duration may be 10 minutes, 20 minutes and so on.

The controller 210 may pass the control to step 509 from step 510, if the time period is less than the threshold duration. However, if at step 512, it is determined that the time period is greater than or equal to the threshold duration, the controller 210 may pass the control to step 514.

At step 514, the controller 210 may determine a distance from the current operating condition to each of the other cost optimized operating conditions. In an embodiment, the controller 210 may determine the distances for the cost optimized operating conditions that provide the powers that are greater than or equal to the power usage value for the current work cycle segment. Referring to FIG. 4, three exemplary cost optimized operating conditions are indicated. The controller 210 may determine the distance between the current operating condition and each of the first, second and third cost optimized operating conditions. In an example, the distance between the current operating condition and the cost optimized operating conditions may be determined using the following equation (2):

Distance=sqrt(torque_distancê2+speed_distancê2) (2)

Further, the controller 210 may determine if each of the determined distances are less than a threshold distance. The threshold distance may correspond to a distance above which, switching from the current operating condition to the corresponding operating condition may result in an undesirable transient event. Moreover, components of the machine 100, such as the transmission 140, the engine 120 and the like may experience high rate of change of corresponding parameters to enable the switching. In an example, threshold distance may correspond to a distance above which, the switching includes changing the engine speed or the torque by a large amount. In another example, the switching may not be possible within the current transmission ratio for the transmission 140.

The controller 210 may pass the control to step 509, if each of the distances are greater than the threshold distance. However, if it is determined that at least one of the distance is less than or equal to the threshold distance, the controller 210 may pass the control to step 516.

At step 516, the controller 210 may determine the operating costs at each of the cost optimized operating conditions that are within the threshold distance. As discussed above, each of these cost operating conditions determined at step 514 provide the powers that are greater than or equal to the power usage value for the current work cycle segment. At step 516, the controller 210 may further determine a low cost operating condition corresponding to an operating cost that is lowest among the determined operating costs.

At step 518, the controller 210 may adjust the transmission 140 to obtain the low cost operating condition. In an example, adjusting the transmission 140 may include adjusting the engine speed corresponding to the low cost operating condition. Additionally or optionally, the controller 210 may adjust the torque of the engine 120 to obtain the low cost operating condition.

Referring to FIG. 5, for example, the controller 210 may determine that the first, second and third cost optimized operating conditions 404, 406, 408 may have a power usage value greater than or equal to the power usage value for the work cycle segment that the machine 100 may be currently operated. Accordingly, the controller 210 may determine the distances of each of the first, second and third cost optimized operating conditions 404, 406, 408 from the current operating condition 402 at step 514. The controller 210 may determine that the distance of the third cost optimized operating condition 408 is greater than the threshold distance. For example, the switching from the current operating condition 402 to the third cost optimized operating condition 408 includes changing the engine speed from 1250 rpm at the current operating condition 402 to 1600 rpm at the third cost optimized operating condition 408.

At step 514, the controller 210 may determine that the first and second cost optimized operating conditions 404, 406 are within the threshold distance from the current operating condition 402. For example, the current operating condition 402 may correspond to an engine speed of 1250 rpm and have an operating cost of 220 units. The unit of the cost may correspond to any value, such as a currency value. The first cost optimized operating condition 404 may correspond to an engine speed of 1150 rpm and have an operating cost of 212 units. The second cost optimized operating condition 406 may correspond to an engine speed of 1300 rpm and have an operating cost of 209 units. In such a case, the controller 210 may determine the second cost optimized operating condition 406 as the low cost operating condition.

Accordingly, at step 516, the controller 210 may regulate the transmission 140 to obtain the low cost operating condition corresponding to the second cost optimized operating condition 406 by increasing the engine speed to 1300 rpm. Moreover, the controller 210 may also vary the torque of the engine 120 as needed to meet the power demand, i.e., the power usage value of the machine 100 work cycle.

Although, the controller 210 is illustrated as a separate unit, it may be envisioned to configure the machine controller 204 or the ECM 202 to implement one or more functions of the controller 210 that are described herein. For example, the machine controller 204 may be configured to determine the operating cost map 400.

### INDUSTRIAL APPLICABILITY

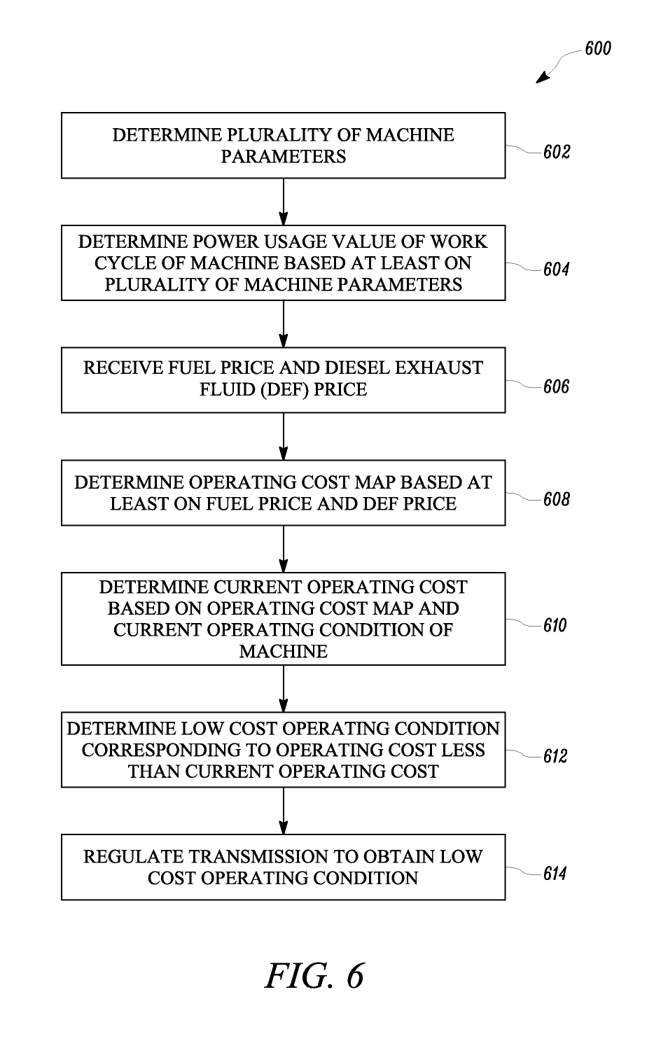

Referring to FIG. 6, a method 600 of operating a machine is illustrated. The method 600 will be explained in conjunction with the machine 100 of FIG. 1. However, it may be envisioned to implement the method 600 in any other machine 100 having an engine and a transmission drivably coupled to the engine 120. In an embodiment, one or more steps of the method 600 may be implemented by the controller 210. For example, the controller 210 may implement the adjustment strategy 500 described with reference to FIG. 3 in order to implement the method 600.

At step 602, the method 600 includes determining a plurality of machine parameters. The machine parameters may include the engine speed, the torque, the fuel rate, the DEF rate, information related to work cycles of the machine 100, the information related to the transmission 140, such as a pressure and a speed of each of the hydraulic pump and the hydraulic motor, and the like.

At step 604, the method 600 includes determining the power usage value of the work cycle of the machine 100 based at least on the machine parameters. The method 600 may include identifying a work cycle or a segment of the work cycle for the machine 100. In an example, the work cycle may be identified based on one or more machine parameters, such as a payload, a grade, a direction of travel and the like. Further, the method 600 may include determining the power usage value for the identified work cycle segment based on a predetermined relationship, a map, a look-up table and the like.

At step 606, the method 600 includes receiving the fuel price and the DEF price. At step 608, the method 600 includes determining the operating cost map 400 based at least on the fuel price and the DEF price. The operating cost map 400 includes a relationship between the operating condition of the machine 100 and a corresponding operating cost. As discussed above, the operating condition is based on at least one of the plurality of machine parameters. In an example, the operating condition may correspond to a combination of the engine speed and the torque.

At step 610, the method 600 includes determining the current operating cost based on the operating cost map 400 and a current operating condition of the machine 100. In an embodiment, the engine speed and the torque may be determined and the corresponding current operating cost may be determined from the operating cost map 400.

At step 612, the method 600 includes determining the low cost operating condition corresponding to an operating cost less than the current operating cost. Moreover, the low cost operating condition corresponds to a power of the engine 120 that is greater than or equal to the power usage value. At step 614, the method 600 includes regulating the transmission 140 to obtain the low cost operating condition. In an embodiment, at least one of the engine speed and the torque may be regulated to obtain the lost cost operating condition.

As the machine 100 is equipped with the aftertreatment systems, such as the SCR that employs DEF to reduce the amount of NOx, the DEF price may also add to an overall operating cost of the machine 100 along with the fuel price. Moreover, the fuel price and the DEF price may vary depending on a location and also from time to time. The method 600 of the present disclosure utilizes the current values of both the fuel price and the DEF price to determine the operating cost map 400 and thereby the current operating cost. As such, by selecting the low cost operating condition based on these prices, the operating cost may be effectively optimized.

Additionally, the method 600 includes determining the work cycle segments of the work cycle in which the machine 100 is operating and further determining a power demand, such as the power usage values for the work cycle segment. As such, the low cost operating condition may be determined so as to meet the power demand of the work cycle segment. Moreover, the method 600 also includes selecting the low cost operating condition that is within the threshold distance form the current operating condition thereby avoiding any undesirable transient events.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of operating a machine having an engine and a transmission drivably coupled to the engine, the method comprising:
determining a plurality of machine parameters;
determining a power usage value of a work cycle of the machine based at least on the plurality of machine parameters;
receiving a fuel price and a Diesel Exhaust Fluid (DEF) price;
determining an operating cost map based at least on the fuel price and the DEF price, wherein the operating cost map comprises a relationship between an operating condition of the machine and a corresponding operating cost, wherein the operating condition is based on at least one of the plurality of machine parameters;
determining a current operating cost based on the operating cost map and a current operating condition of the machine;
determining a low cost operating condition corresponding to an operating cost less than the current operating cost, wherein a power of the machine corresponding to the low cost operating condition is greater than or equal to the power usage value; and
regulating the transmission to obtain the low cost operating condition.
